(19) United States
(12) Patent Application Publication
(10) Pub. No.: US 2022/0192104 A1
(43) Pub. Date: Jun. 23, 2022

(54) KITS AND METHODS FOR PREPARING SEEDS FOR GERMINATION

(71) Applicant: OMS Investments, Inc., Los Angeles, CA (US)

(72) Inventors: Alex Patrick Borges, Columbus, OH (US); Eric Kingsley Nelson, Englewood, FL (US); Eric David Koch, Marysville, OH (US)

(21) Appl. No.: 17/554,852

(22) Filed: Dec. 17, 2021

Related U.S. Application Data
(60) Provisional application No. 63/127,799, filed on Dec. 18, 2020.

(51) Int. Cl. A01G 9/029; A01G 24/42; A01G 24/15

(52) U.S. Cl. CPC A01G 9/0293; A01G 24/15; A01G 24/42

(57) ABSTRACT

Kits for seed pre-germination are included. The kit includes a storage vessel and a seeding composition. The seeding composition includes plant seeds, a porous granular material, and a polymer-coated fertilizer. Methods for preparing seeds for germination are also included. The method includes combining the seeding composition with water in the storage vessel and sealing the storage vessel, such that little to no aeration is permitted during subsequent storage of the same.

### REFERENCE TO RELATED APPLICATIONS

The present application claims the priority of U.S. provisional application Ser. No. 63/127,799, entitled KITS AND METHODS FOR PREPARING SEEDS FOR GERMINATION, filed Dec. 18, 2020, and hereby incorporates the same application herein by reference in its entirety.

### TECHNICAL FIELD

The present disclosure relates generally to kits and methods for preparing seeds for germination. Specifically, the kits and methods allow for consumers to effect seed pre-germination in a storage vessel and apply as desired.

### BACKGROUND

Cultivating and/or maintaining a healthy lawn is a do-it-yourself challenge that many consumers try to tackle. However, with respect to growing grass, many consumers find themselves unsuccessful. Such lack of success is often attributable, in large part, to a failure to provide the level of care necessary to effectively establish turf from seed. For example, the amount of watering required can be demanding, and consumers often fail to water frequently enough on a daily basis and/or for the entirety of the prescribed duration.

There are several known methods dedicated to facilitating the seed-growing experience for consumers and improving the efficiency thereof. Such methods can involve the preparation and treatment of seeds prior to planting, e.g., seed priming and pre-germination methods. Seed priming, for example, involves exposing seeds to water prior to sowing and then slowing or halting the hydration process prior to germination, i.e., any penetration of a root or shoot through a seed coat. Typically, priming is conducted commercially, on a large scale, and seeds are separated from other components used in the priming process and dried to increase shelf life prior to shipment, distribution, and/or storage. In contrast, pre-germination methods involve exposing seeds to water until germination, i.e., penetration of a root or shoot through a seed coat, has occurred. However, even after applying such pre-planting methods, consumers have still experienced issues in effectively establishing turf.

It would be desirable to address such issues by, among other things, further simplifying the grass-growing process, increasing the speed of germination and establishment, and allowing for visual confirmation of germination prior to planting. It would further be desirable to reduce the level of consumer effort required while facilitating consumer engagement.

### SUMMARY

According to one embodiment, a pre-germination kit includes a storage vessel and a seeding composition. The seeding composition includes plant seeds; a polymer-coated fertilizer; and a porous granular material.

According to another embodiment, a method for preparing seeds for germination includes providing a storage vessel and a seeding composition, wherein the seeding composition includes plant seeds, a polymer-coated fertilizer; and a porous granular material; adding water to the storage vessel to mix with the seeding composition to form a pre-germination mixture; sealing the storage vessel, such that no additional aeration is permitted during subsequent storage of the sealed storage vessel; storing the sealed storage vessel until a germinated product is formed; and spreading the germinated product.

### BRIEF DESCRIPTION OF THE DRAWINGS

FIG. 1 depicts a front view of a pouch according to one embodiment;

FIG. 2 depicts a rear view of the pouch of FIG. 1, with a first sealable opening in a partially closed position;

FIGS. 3A, 3B, 3C, and 3D are images showing growth of an inventive example germinated product at three, four, five, and six days after planting, respectively, and FIGS. 3E, 3F, 3G, and 3H are images showing growth of a comparative example germinated product at three, four, five, and six days after planting, respectively; and

FIG. 4A is an image showing growth of a comparative example germinated product at four weeks after planting, and FIG. 4B is an image showing growth of an inventive example.

### DETAILED DESCRIPTION

Kits and methods for preparing seeds for germination for consumer use are described herein. A kit for seed pre-germination can include a storage vessel and a seeding composition. The seeding composition includes plant seeds, a polymer-coated fertilizer, and a porous granular material. The storage vessel can house the seeding composition. The storage vessel can further be configured or sized to contain water in an amount sufficient to effect pre-germination of the plant seeds. The seeding composition (e.g., plant seeds, polymer-coated fertilizer, and porous granular material) can be combined with water to form a pre-germination mixture. The pre-germination mixture can be stored in the storage vessel, which can be sealed to permit no additional aeration, until germination of the plant seeds. In certain embodiments, the germinated product can be spread to a planting area using suitable methods of application.

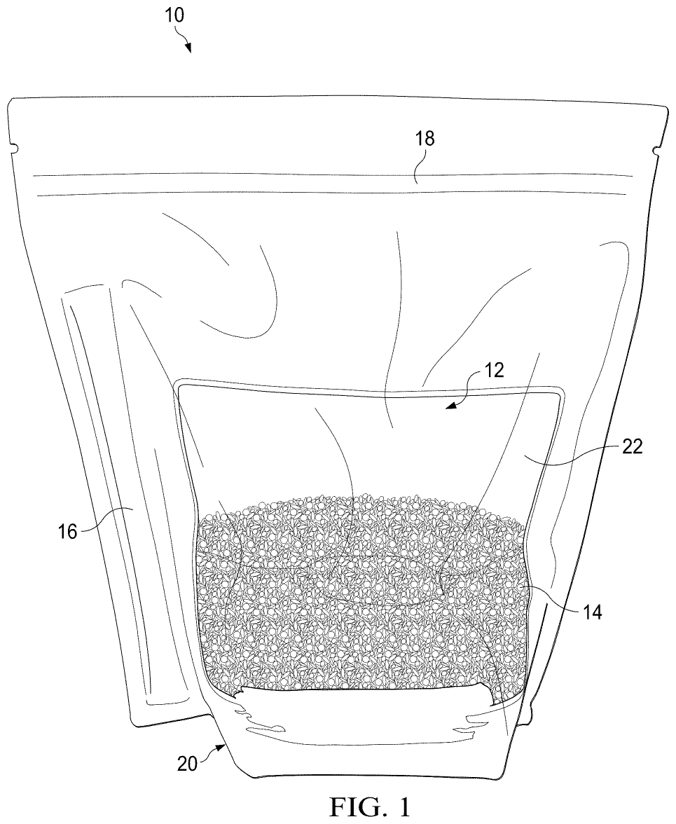

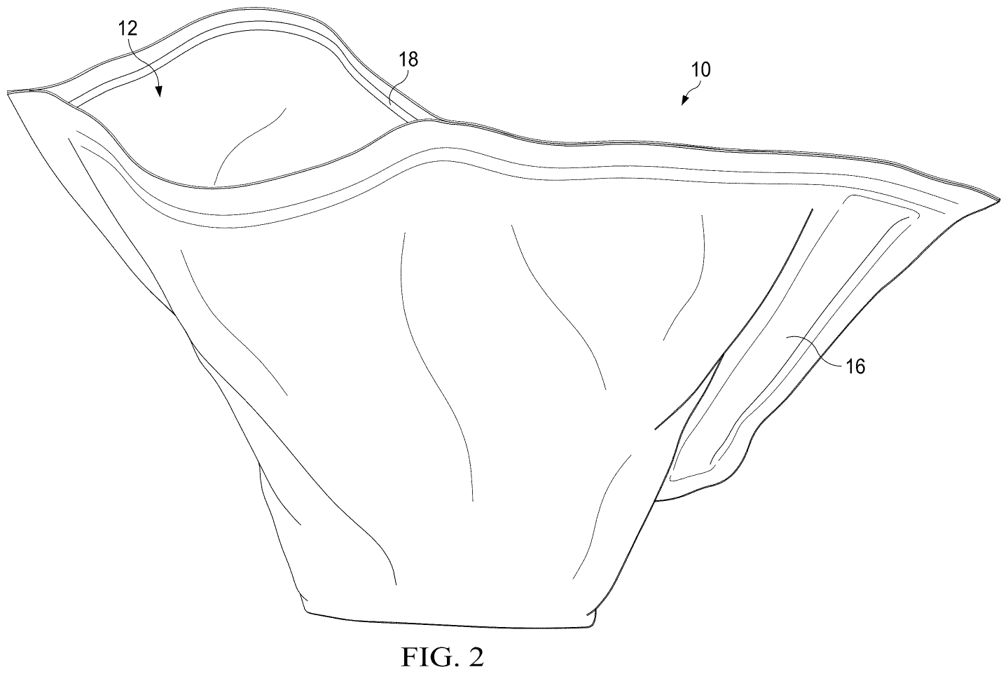

In certain embodiments, the storage vessel can be a pouch 10, as shown, for example, in FIGS. 1 and 2. In such embodiments, the pouch 10 can define a cavity 12, which can be configured to contain, among other things, the seeding composition 14 and water. The pouch 10 can further define one or more sealable openings through which the seeding composition 14 and water, for example, can be loaded into the cavity 12 or from which the germinated product, for example, can be poured, such that the storage vessel (e.g., 10) can serve as a product application device. In some embodiments, one sealable opening can be employed for loading and another can be employed for pouring, while in other embodiments, one sealable opening can be employed for both functions. As shown, for example, in FIGS. 1 and 2, the pouch 10 can further include a spine 16, which can be a rigid support to be used, for example, as a handle for facilitating pouring. In certain embodiments, a first sealable opening 18 can include a resealable zip feature. As shown in FIG. 2, the first sealable opening 18 can be partially sealed for a more precise application when pouring. In certain embodiments, a second sealable opening can be a spout including a twist cap. It will be appreciated that a pouch may include one or more of the first sealable opening 18, the second sealable opening, or any of a variety of other suitable sealable openings. In some embodiments, the pouch 10 can include a bottom gusset 20 for support and to allow a consumer to place a sealed pouch in an upright position.

In certain embodiments, the pouch 10 can be formed of a soft or rigid plastic material. In some embodiments, the material can be malleable, such that the pouch 10 and its contents can be effectively kneaded. However, it will be appreciated that a storage vessel may be formed from any other suitable types of plastic or any of a variety of other suitable materials. It will also be appreciated that a storage vessel can vary in size depending on the amount of seeding composition selected to be housed therein. Further, it will be appreciated that, alternatively, a storage vessel can be a bag, bottle, bucket, canister, carton, crate, sack, tank, or any of a variety of other suitable containers in any of a variety of suitable configurations.

The degree to which the storage vessel's contents are aerated can be controlled, such that in certain embodiments, aeration of the storage vessel may be limited, restricted, or eliminated. For example, in certain embodiments, the storage vessel may include a plurality of perforations to allow for aeration of the storage vessel's contents. In such embodiments, the plurality of perforations can be provided in one or more arrays. However, in other embodiments, the storage vessel can be free of or substantially free of any perforations, such that the storage vessel, when sealed, does not allow for any aeration of the storage vessel's contents. In certain embodiments, the storage vessel can be water impermeable. It will be appreciated that any perforations included on a storage vessel can be microperforations. In certain embodiments, the storage vessel may contain about 5% or less of oxygen during the pre-germination process; and in certain embodiments, about 2% or less of oxygen during the pre-germination process.

In certain embodiments, the kit may be provided to a consumer with the seeding composition in the storage vessel. In such embodiments, the storage vessel may serve as packaging. In some of such embodiments, the storage vessel may include perforations on a perforated portion thereof In such embodiments, the storage vessel, as packaging for example, may include a removable portion having one or more perforations, and upon removal of the removable portion, the storage vessel can be free of or substantially free of any perforations. In other embodiments where the storage vessel may serve as packaging, the storage vessel may include one or more perforations positioned on a first portion thereof, such that when the storage vessel is sealed for storage, a second, sealed portion of the storage vessel can be free of or substantially free of any perforations.

In other embodiments, the kit may be provided to a consumer with the seeding composition separate from the storage vessel. In such embodiments, the kit may include packaging that houses both the seeding composition and the storage vessel. In certain embodiments, the packaging may include a plurality of perforations to allow for aeration of the contents of the packaging and the storage vessel can be can be free of or substantially free of any perforations.

In some embodiments, the storage vessel can include one or more windows. For example, as shown in FIG. 1, the pouch 10 includes a window 22 that can allow a consumer to view the progress of a pre-germination process. For example, the window 20 can provide a visual indication of the degree to which penetration of roots or shoots through seed coats, i.e., germination, is occurring to determine whether the storage vessel contents have matured into a germinated product and are ready for planting. While FIGS. 1 and 2 depict a pouch having a window only on a front portion thereof, it will be appreciated that a window may be provided on one or both of a front and rear portion thereof.

In some embodiments, the kit can further include a set of instructions for use to a consumer. In such embodiments, the set of instructions can be included on a separate paper or pamphlet within the storage vessel or other form of packaging. In other such embodiments, the set of instructions can be printed directly on the storage vessel or other form of packaging. It will be appreciated that a storage vessel may additionally or alternatively include other types of indicia printed thereon.

In certain embodiments, the seeding composition can include plant seeds. Plant seeds that are suitable for use in the kits described herein can be any of a variety of species. In certain embodiments, the seed can be grass seed, such as perennial ryegrass, fine fescue, Kentucky bluegrass, tall fescue, bermudagrass, zoysiagrass, bahiagrass, centipedegrass, or mixtures thereof. In one embodiment, the seed can be a mixture of perennial ryegrass, Kentucky bluegrass, and fine fescue. In some embodiments, the seeds can be for plant species that are agronomically important. Such plant species can include, but are not limited to, corn, peanut, canola/rapeseed, soybean, curcubits, crucifers, cotton, rice, sorghum, sugar beet, wheat, barley, rye, sunflower, tomato, sugarcane, tobacco, oats, as well as other vegetable and leaf crops. In certain embodiments, the seed can be treated, for example, with a fungicide. The seeding composition, in certain embodiments, can include from about 5% to about 30%, by weight; from about 10% to about 25%, by weight; from about 12% to about 20%, by weight; or from about 15% to about 18%, by weight, of plant seeds. As can be appreciated, the amount of plants seeds present in the seeding composition may vary depending on the varietal of plant seed selected.

In certain embodiments, the seeding composition can include a porous granular material. The porous granular material can be a solid, water-holding material that maintains its structure and shape when introduced to moisture. In certain embodiments, the porous granular material is a porous clay material. The seeding composition may employ any of a variety of suitable granular, porous materials having absorbent characteristics. In one embodiment, the porous granular material can be calcined clay, such as, for example, montmorillonite clay. Other suitable porous granular materials can include attapulgite, clays, bentonite clays, and mixtures thereof. The seeding composition, in certain embodiments, can include from about 60% to about 90%, by weight; from about 65% to about 85%, by weight; from about 72% to about 80%, by weight; or from about 75% to about 79%, by weight, of a porous granular material.

In certain embodiments, the seeding composition can include a polymer-coated fertilizer. In some embodiments, the fertilizer can be a nitrogen-based fertilizer. In such embodiments, the nitrogen-based fertilizer can be any fertilizer that releases plant readily available nitrogen. For example, in certain embodiments, the nitrogen-based fertilizer can be urea, a urea formaldehyde reaction product, or a combination of multiple nitrogen-containing compounds. Suitable nitrogen-based fertilizers can include slow-release nitrogen compounds, such as methylenediurea (“MDU”), dimethylenetriurea (“DMTU”), triazones, urea-triazones (such as tetrahydro-s-triazone or 5-methyleneuriedo-2-oxohexahydro-s-triazine), and isobutylidene-diurea (“IBDU”), which can allow for tailoring of the nitrogen release profile over time. Other, organic sources of nitrogen can include one or more of bone-meal, feather meal, blood meal, animal manures, bat and/or bird guano, bio-solids, compost, worm castings, leguminous plant-based meals (e.g., soy, alfalfa), and sea kelp. It will be appreciated that the fertilizer may include any plant macronutrients (e.g., nitrogen, phosphorous, potassium) essential for plant growth. Thus, in some embodiments, the fertilizer can be a phosphorous-based fertilizer. For example, sources of phosphorous may include, for example, one or more of superphosphate (OSP), triple superphosphate (TSP), monoammonium phosphate (MAP), diammonium phosphate (DAP), or ammonium polyphosphate (APP). In certain embodiments, sources of potassium may include, for example, one or more of potassium nitrate, potassium sulfate, or potassium chloride.

It will be appreciated that the fertilizer can be coated with a polymer that allows for a controlled release of nitrogen. For example, suitable polymers for use in the polymer coating can include one or more of polyurethane, latex, polyethylene, wax, and linseed oil resin. In one embodiment, the polymer used for the polymer coating of the fertilizer can allow for the controlled release of nitrogen. In one example, the polymer used for the polymer coating of the fertilizer can allow for the controlled release of nitrogen over 90 days, but it will be appreciated that the polymer used for the polymer coating may allow for the controlled release of nitrogen for shorter or longer time periods. In addition to such controlled release of nitrogen, in some embodiments, the polymer used for the polymer coating may facilitate seed safety, providing protection for the same when wet and/or dry. The seeding composition, in certain embodiments, can include from about 1% to about 15%, by weight; from about 2% to about 10%, by weight; from about 2% to about 8%, by weight; or from about 4% to about 6%, by weight, of a polymer-coated fertilizer.

As described above, in order to effect germination thereof, the seeding composition can be combined with water to form a pre-germination mixture. In certain embodiments, the amount of water added can be from about 0.25 cups to about two cups per pound of the seeding composition; from about 0.5 cups to about 1.5 cups per pound of the seeding composition; from about 0.75 cups to about 1.25 cups per pound of the seeding composition; from about 0.9 cups to about 1.1 cups per pound of the seeding composition; or about one cup per pound of the seeding composition. In one embodiment, for example, about three cups of water can be combined with three pounds of seeding composition to form a pre-germination mixture. It will be appreciated, however, that the amount of water can be dependent upon the specific components and amounts thereof used in the seeding composition.

The amount of water added can also be dependent upon water potential, a measure of water availability. For example, in certain embodiments, the water potential of a mixture can be from about −0.4 MPa to about −1.0 MPa, or more preferably, from about −0.5 MPa to about −0.8 MPa. Without wishing to be bound by theory, it is believed that providing a pre-germination mixture having a water availability higher (or wetter) than −0.4 would compromise flowability, while providing a pre-germination mixture having a water availability lower (or drier) than -1.0 would limit visual emergence of roots and shoots through seed coats.

Additional components can include, but are not limited to biostimulants, germination stimulants (e.g., gibberellic acid), fungicides, antioxidants, nutrients, or other growth enhancers. For example, in certain embodiments, biostimulants (e.g., plant stimulants) can include substances and/or microorganisms that can stimulate natural processes that enhance nutrient uptake and the efficiency thereof, improve tolerance to abiotic stress, regulate plant water uptake, and enhance development of complementary soil microorganisms. In certain embodiments, biostimulants may be introduced directly to the seed or root rhizosphere for contact therewith and/or imbibement therein. For example, biostimulants may be included within an emulsion, such that the seeds or roots may be soaked in the same. Such biostimulants and/or other additional components could be contained, for example, within the seeding composition or on one or more components thereof (e.g., via spraying) or such biostimulants and/or other additional components may be provided as standalone materials (i.e., separate from the seeding composition) to be mixed with and/or activated by water before the water is added to form the pre-germination mixture. Other examples of the above-described types of additional components can include plant hormones, beneficial microorganisms including bacteria and fungi, amino acids, micronutrients, phenolic compounds, inorganic elements, and plant bio-defense elicitors. Such examples may be introduced as described above or by any of a variety of known processes.

Methods for preparing seeds for germination can include providing the kit for pre-germination, as described above. A method for preparing seeds for germination can include providing a storage vessel and a seeding composition including plant seeds, a polymer-coated fertilizer; and a porous granular material, all of which are described herein. And as described, in certain embodiments, the seeding composition may be provided to a consumer in the storage vessel. In other embodiments, the seeding composition may be provided to a consumer separate and apart from the storage vessel. In such embodiments, the method for preparing seeds for germination can further include placing a predetermined amount of the seeding composition into the storage vessel.

In certain embodiments, the method for preparing seeds for germination can further include adding water to the storage vessel to mix with the seeding composition to form a pre-germination mixture. As described above, a consumer can add a desired amount of water to the storage vessel. For example, in certain embodiments, a consumer can add about 1 cup of water per pound of seeding composition.

In certain embodiments, the method for preparing seeds for germination can further include sealing the storage vessel, such that little to no aeration is permitted during subsequent storage of the sealed storage vessel. In many seed-growing methods, aeration and exposure to oxygen is encouraged. However, without wishing to be bound by theory, it is believed that limiting the amount of oxygen can limit excessive elongation of roots and/or shoots. In certain embodiments, the method can further include mixing the pre-germination mixture to evenly distribute the water. For example, mixing the pre-germination mixture can include shaking and/or kneading the storage vessel to evenly distribute the water. In other embodiments, the method can include allowing for ventilation of the storage vessel through perforations, or in some cases, microperforations, provided thereon. It will be appreciated that, in such embodiments, a number of perforations can be minimal to limit the aeration of the storage vessel.

In certain embodiments, the method for preparing seeds for germination can further include storing the sealed storage vessel until a germinated product is formed. In some embodiments, storing the sealed storage vessel can require a consumer to place the sealed storage vessel in an upright position. Storing the sealed storage vessel until a germinated product is formed can last, in certain embodiments, from about two days to about ten days; from about two days to about seven days; and from about three days to about five days. In certain embodiments, a consumer may need to wait to allow for sufficient germination to occur prior to application of the product. As described above, in certain embodiments, the storage vessel may include one or more windows to view the progress of a germination process without having to unseal the storage vessel. The windows can be made of a material that allows sufficient light to pass so that a consumer can visually tell whether pre-germination has in fact occurred. Accordingly, in certain embodiments, storing the sealed storage vessel until a germinated product is formed can further include visually confirming germination through a window of a storage vessel.

In some embodiments, germination can occur at temperatures from about 60° F. to about 85° F. In one embodiment, germination can occur at about 70° F. Accordingly, germination can be accomplished indoors or outdoors. In a preferred embodiment, germination may be conducted indoors to limit exposure of the storage vessel and its contents to direct sunlight and/or temperature swings. In certain embodiments, germination can be accomplished under light or dark conditions.

In certain embodiments, the method for preparing seeds for germination can include applying the germinated product to a desired planting area. According to one embodiment, a germinated product based on three pounds of a seeding composition can cover a desired planting area of about 100 ft². In some embodiments, a consumer can be required to ensure that the desired planting area is sufficiently prepared to receive the germinated product. For example, in such embodiments, the method can further include loosening soil in the desired planting area. In one such embodiment, a depth of the soil loosened in the desired planting area can be about 1 inch.

In certain embodiments, applying the germinated product to a desired planting area can further include mixing (e.g., shaking and/or kneading), again, the germinated product. It is believed that such mixing can facilitate application of the germinated product. Application of the germinated product to a desired planting area can include spreading the germinated product over the desired planting area. In certain embodiments, the germinated product can be applied, and optionally spread, directly from the storage vessel. In other embodiments, the germinated product can be applied and spread via hand or shaker-package applicators or via a mechanical or hydraulic applicator. Without wishing to be bound by theory, it is believed that the germinated product can be flowable in an applicator, such that the germinated product can be effectively distributed over the desired planting area. It will be appreciated, however, that the germinated product can be applied to any suitable planting area by any of a variety of suitable methods for spreading seeds.

Subsequent to application of the germinated product, a consumer can be required to further attend to and/or maintain the desired planting area. For example, in certain embodiments, the germinated product may be raked into soil of the desired planting area. It will be appreciated that a consumer may be required to conduct such raking in a gentle manner. Alternatively, soil may be provided over the top of the germinated product. In certain embodiments, once placed in the desired planting area, the germinated product may subsequently be watered. For example, in certain embodiments, daily watering from about two weeks to about four weeks, for about three weeks, or until full seed growth is realized may be recommended for a consumer. It is believed that the above described methods can result in faster germination and establishment times.

### EXAMPLES

Example formulations of the seeding composition are provided below in Table 1.

TABLE 1
Inventive Example 1

| Component | Amount (wt. %) |
|---|---|
| Grass Seed | 17 |
| Calcined Clay | 77.5 |
| Polymer-coated Fertilizer | 5.5 |

As described above in Table 1, Example 1 is a seeding composition including grass seed, calcined clay, and a polymer coated fertilizer. In particular, the grass seed is a mixture of perennial ryegrass, fine fescue, and Kentucky bluegrass; the calcined clay is montmorillonite clay; and the poly-coated fertilizer is a polymer-coated urea.

With respect to the air composition of in the headspace of the storage vessel upon sealing of the same, the air typically includes 20.9% oxygen (O₂) and 0.03% carbon dioxide (CO₂). Table 2 shows a comparison of such levels for each of a restrictive storage vessel and non-restrictive storage vessel after three days of housing a pre-germination mixture.

TABLE 2
Comparison of Air Composition for Restrictive
vs. Non-restrictive Storage Vessels

| | Restrictive Vessel | Non-restrcitve |
|---|---|---|
| Component | (%) | Vessel (%) |
| Oxygen (O₂) | 2 | 8 |
| Carbon Dioxide (CO₂) | 11 | 3 |

As shown above, the air components in the storage vessel that restricts aeration of its contents change more dramatically than the storage vessel that does not provide such restrictions. In particular, relative to the typical composition described above, the O₂ level in the restrictive storage vessel is more greatly reduced than that of the non-restrictive storage vessel, while the CO₂ level in the restrictive storage vessel experiences a larger increase than that of the non-restrictive storage vessel. It is believed that reducing the amount of O₂ available to the seeds through use of restrictive storage vessel (i.e., non-perforated) can improve shelf life and vigor of the pre-germination mixture and prevent overgrowth during a storage period. Reduction of such overgrowth can, for example, reduce the amount of monitoring required by a consumer and facilitate a seed growing process.

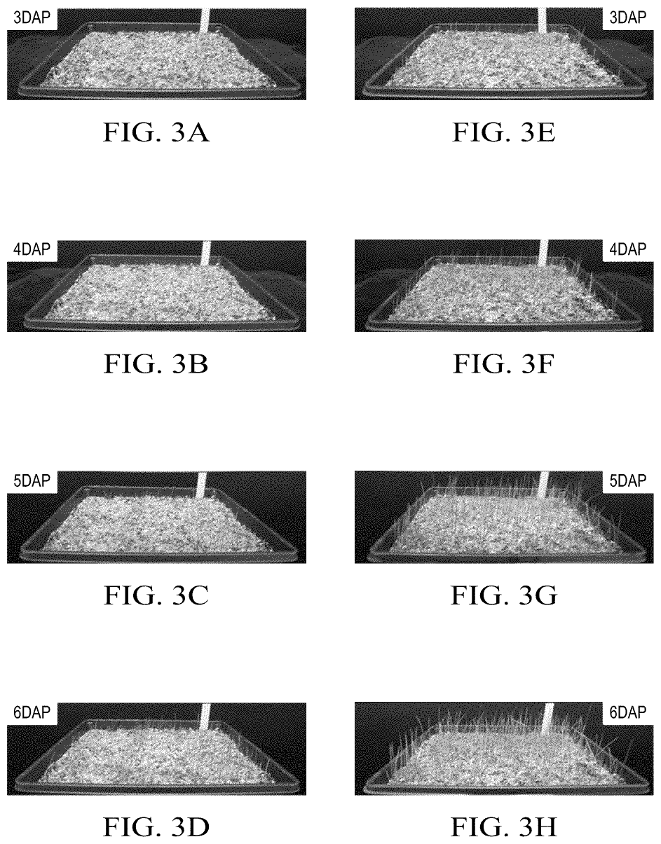

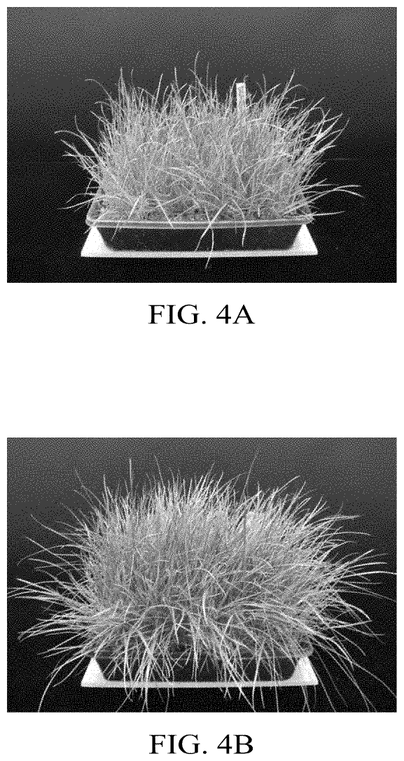

FIGS. 3A-3H and FIGS. 4A-4B depict a comparison of the results of grass grown using a germinated product obtained using a seeding composition as described herein (Inventive Example 2) versus a germinated product obtained with a conventional seeding composition (Comparative Example 3). Inventive Example 2 includes grass seed, calcined clay, and a polymer-coated fertilizer. Comparative Example 3 includes grass seed and a conventional fertilizer. As shown in FIGS. 3A-3H, at each of three, four, five, and six days after planting, Inventive Example 2 (FIGS. 3E-3H) provided faster and more robust seed growth than Comparative Example 3 (FIGS. 3A-3D). Furthermore, and as shown in FIGS. 4A-4B, Inventive Example 2 (FIG. 4B) continued to outgrow Comparative Example 3 (FIG. 4A) at four weeks after planting.

As used herein, all percentages (%) are percent by weight of the total composition, also expressed as weight/weight %, % (w/w), w/w, w/w % or simply %, unless otherwise indicated.

The dimensions and values disclosed herein are not to be understood as being strictly limited to the exact numerical values recited. Instead, unless otherwise specified, each such dimension is intended to mean both the recited value and a functionally equivalent range surrounding that value.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in the document shall govern.

The foregoing description of embodiments and examples has been presented for purposes of description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent articles by those of ordinary skill in the art. Rather it is hereby intended the scope be defined by the claims appended hereto.

What is claimed is:

1. A pre-germination kit, the kit comprising:
a storage vessel; and
a seeding composition including:
plant seeds;
a polymer-coated fertilizer; and
a porous granular material.

2. The kit of claim 1, wherein the plant seeds are grass seed.

3. The kit of claim 1, wherein the fertilizer is a nitrogen-based fertilizer.

4. The kit of claim 3, wherein the nitrogen-based fertilizer is urea.

5. The kit of claim 1, wherein the porous granular material is calcined clay, and wherein the calcined clay is montmorillonite clay.

6. The kit of claim 1, wherein the seeding compositions comprises:
from about 12% to about 20%, by weight, of plant seeds;
from about 2% to about 8%, by weight, of fertilizer; and
from about 72% to about 80%, by weight, of porous granular material.

7. The kit of claim 6, wherein the seeding composition comprises from about 15% to about 18%, by weight, of plant seeds.

8. The kit of claim 6, wherein the seeding composition comprises from about 4% to about 6%, by weight, of fertilizer.

9. The kit of claim 6, wherein the seeding composition comprises from about 75% to about 79%, by weight, of porous granular material.

10. The kit of claim 1, wherein the storage vessel comprises a window to provide a visual indication of pre-germination progress.

11. The kit of claim 1, wherein the storage vessel is completely non-perforated.

12. The kit of claim 1, wherein the storage vessel does not allow for aeration.

13. The kit of claim 1, wherein the storage vessel further comprises an array of perforations.

14. The kit of claim 1, wherein the storage vessel is a product application device.

15. A method for preparing seeds for germination, the method comprising:
providing a storage vessel and a seeding composition, wherein the seeding composition includes plant seeds, a polymer-coated fertilizer; and a porous granular material;
adding water to the storage vessel to mix with the seeding composition to form a pre-germination mixture;
sealing the storage vessel, such no additional aeration is permitted during subsequent storage of the sealed storage vessel;
storing the sealed storage vessel until a germinated product is formed; and
applying the germinated product to a desired planting area.

16. The method of claim 15, wherein an amount of the water added to the storage vessel is about 1 cup of water per pound of seeding composition.

17. The method of claim 15, wherein sealing the storage vessel further comprises shaking the storage vessel to evenly distribute the water with the seeding composition.

18. The method of claim 15, wherein storing the sealed storage vessel until a germinated product is formed lasts from about two days to about ten days.

19. The method of claim 15, wherein storing the sealed storage vessel until a germinated product is formed further comprises visually confirming germination through a window of the storage vessel.

20. The method of claim 15, wherein the storage vessel comprises about 5% or less of oxygen once sealed as the germinated product is formed.
